(19) United States
(12) Patent Application Publication
(10) Pub. No.: US 2026/0154722 A1
(43) Pub. Date: Jun. 4, 2026

(54) RE-RANKING QUERY SEARCH RESULTS USING TEMPORAL-BEHAVIORAL AND CONTEXT-AWARE FEATURES

(71) Applicant: Walmart Apollo, LLC, Bentonville, AR (US)

(72) Inventors: Qi Liu, Jersey City, NJ (US); Atul Singh, Jersey City, NJ (US); Jingbo Liu, Princeton, NJ (US); Cun Mu, New York, NY (US); Zheng Yan, Short Hills, NJ (US); Jan Pedersen, Los Altos Hills, CA (US)

(73) Assignee: Walmart Apollo, LLC, Bentonville, AR (US)

(21) Appl. No.: 18/964,112

(22) Filed: Nov. 29, 2024

(51) Int. Cl. G06Q 30/0601; G06N 5/01

(52) U.S. Cl. CPC G06Q 30/0625; G06N 5/01

(57) ABSTRACT

A system is provided including a processor and a non-transitory computer-readable medium storing computing instructions that, when executed on the processor, cause the processor to perform operations including: obtaining a plurality of query-item pairs associated with a query, wherein the plurality of query-item pairs associated with the query are initially ranked at least partially based on user engagement metrics; obtaining, for each query-item pair of the plurality of query-item pairs associated with the query, first temporal-behavioral features, second temporal-behavioral features, and context-aware features, wherein the context-aware features include a vertical of the query; generating, using a Gradient Boosted Decision Tree (GBDT) model, respective query-item pair GBDT output values based on respective inputs for each query-item pair of the plurality of query-item pairs associated with the query, wherein the respective inputs for each query-item pair of the plurality of query-item pairs associated with the query are based on the first temporal-behavioral features, the second temporal-behavioral features, and the context-aware features; and re-ranking at least some of the plurality of query-item pairs associated with the query that are initially ranked based on the respective query-item pair GBDT output values.

### TECHNICAL FIELD

The present disclosure relates generally to re-ranking query search results, and more particularly to re-ranking query search results using temporal-behavioral and context-aware features.

### BACKGROUND

When ranking search result products (e.g., items/products and/or query-item/query-product pairs) associated with queries related to various item/product-type categories (e.g., verticals), e-commerce platforms will typically obtain/analyze respective aggregated user engagement data associated with a plurality of users (e.g., customers) for behaviors (e.g., clicks, add-to-carts, orders, etc.) based on a manually selected uniform time window (e.g., 2 years, 1 year, 6 months, or 3 months, etc.). The longer the time window that is selected, the more historical user engagement observations the features can capture; which leads to less sparsity and higher coverage in, for example, ranking model training and/or inferences. The shorter the time window that is selected, the more recent online shopping trends are captured due to recent user behavioral changes, new product launches, and/or influence of seasonality, etc.

### BRIEF DESCRIPTION OF THE DRAWINGS

To facilitate further description of the embodiments, the following drawings are provided in which:

FIG. 1 illustrates a front elevational view of a computer system that is suitable for implementing aspects disclosed herein, according to an example embodiment;

FIG. 2 illustrates a representative block diagram of elements included in the circuit boards inside a chassis of the computer system of FIG. 1, according to an example embodiment;

FIG. 3 illustrates a schematic block diagram of a system that can perform a computer-implemented method for re-ranking query search results using temporal-behavioral and context-aware features, according to an example embodiment; and

FIG. 4 illustrates a flowchart of a computer-implemented method for re-ranking query search results using temporal-behavioral and context-aware features, according to an example embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for various lengths of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DETAILED DESCRIPTION

As aforementioned, when ranking search result items/products associated with queries related to various item/product-type categories, e-commerce platforms will typically obtain/analyze respective aggregated user engagement data associated with a plurality of users for behaviors based on a manually selected uniform time window (e.g., 2 years, 1 year, 6 months, or 3 months, etc.).

However, this one-size-fits-all approach of using the manually selected time window uniform to obtain/analyze the aggregated user engagement data in order to rank search result item/products associated with queries, regardless of respective different item/product-type categories, is suboptimal. This one-size-fits-all approach is suboptimal for various reasons, including variability in user engagement: for different item/product categories inherently, seasonally, and/or based on recent circumstances (e.g., new item/product launches, evolving consumer attitudes, changes in popularities of items, sales, etc.), etc. Different item/product-type categories and the constituent items/products thereof can thus be subject to unique trends in respective user engagement (e.g., user behavior patterns and/or purchasing cycles, etc.). For example, the item/product-type category of fashion and comprising items/products thereof can experience rapid trend changes in user engagement. On the other hand, the item/product-type category of food and comprising items/products thereof can have generally more consistent/predictable long-term patterns of user engagement (except for certain seasonally effected products).

Thus, there is a need for a means to rank and/or re-rank query search results to account for the influence of short time windows and/or long time windows on items/products within respective verticals. Example embodiments disclosed herein are designed in recognition that a more nuanced approach is necessary to capture the unique characteristics of each item/product vertical, such as in view of:
a. Short-Term Trends: verticals with rapidly changing trends can require shorter lookback periods to stay relevant.
b. Long-Term Patterns: some verticals can benefit from longer time windows to capture consistent behavior over time.
c. Category-Specific Optimization: the ideal time window(s) can vary significantly across different verticals.

Some example embodiments disclosed herein are directed to a computer-implemented method for ranking and/or re-ranking query search results using temporal-behavioral and context-aware features. Some other example embodiments disclosed herein are directed to a system and non-transitory computer-readable program instructions that can effectively facilitate the computer-implemented method. The approach enabled by the example embodiments disclosed herein can allow for a more flexible and informed ranking and/or re-ranking determination equipped with adaptive time windows. Example embodiments disclosed herein can, for example, determine: optimal short time windows and/or long time windows per vertical; precise impacts of the short time windows and/or long time windows on user engagement metrics in relation to specific vertical(s) associated with a given query; relative priorities/weightings of the determined impacts on user engagement metrics; and query search result ranking and/or re-ranking of items/products based on the relative priorities/weightings of the determined impacts. Example embodiments disclosed herein can dynamically adjust the time window based on the specific characteristics of each item/product vertical and/or historical user engagement data. Tree-based models can be used to leverage vertical features to decide between, modify, and/or prioritize short and/or long-time windows for each vertical. By adapting to the nuances of each vertical, example embodiments disclosed herein can display items/products to users that are both highly relevant and/or trending within their specific context.

This innovation significantly improves, for example, search query result ranking technologies and technical field thereof. Optimizing query search result rankings involves dynamically adjusting time windows based on user engagement metrics and item/product vertical characteristics. By leveraging sophisticated machine learning processes and/or models that adapt to user behavior and specific vertical inputs, we can dynamically rank and/or re-rank search results. This approach significantly enhances the relevance of search query results, providing more accurate item/product recommendations and improving overall user engagement and satisfaction. Example embodiments disclosed herein also improve the customer shopping experience by ensuring that item/product rankings are tailored to the unique behavioral patterns and trends of each vertical. This ultimately leads to greater customer satisfaction, more accurate search results, and/or reduced need/frequency for comprehensive ranking of products/items for every vertical in the case of re-ranking—thus freeing up computer-based resources for an e-commerce entity.

Some of the aforementioned improvements have been empirically demonstrated by model comparison. The baseline model used a long time window of 730 days, while Model A used a short time window of 30 days. Model B combined both long and short time windows, and Model C (according to an example embodiment) further incorporated context awareness with these time windows.

In Experiment II, the baseline model, which only used a long time window, was compared to Model B, which used both long and short time windows. Model B performed sub-optimally, particularly in the Food, Consumables, and ETS verticals/categories, likely due to the model's lack of flexibility in leveraging different behavioral features for various verticals/categories.

In Experiment III, the baseline model was compared to our example embodiment Model C, which combined both long and short time windows with vertical binary features. Model C improved performance across all general merchandise (GM) verticals/categories and corrected previous declines in Food and Consumables verticals/categories. Model C outperformed the baseline model in multiple business metrics, with a notable gross merchandise value (GMV) lift, indicating the effectiveness of short time window features especially for cold-start products.

| Vertical | Food | Consumables | Home | ETS | Hardlines | Fashion | Overall |
|---|---|---|---|---|---|---|---|
| Change | −0.01% | +0.02% | +0.40%* | +0.78%* | +1.58%* | +0.73%* | +0.22%* |

| | Overall | Marketplace | | Sessions | Session |
|---|---|---|---|---|---|
| Metric | GMV | GMV | ATC@10 | with ATC | Abandonment |
| Lift | +0.12% | +0.64%* | +0.21%* | +0.22%* | −0.16%* |

The multi-window design of Model C captures customer engagement patterns over varying time window durations, both long/stable and short/dynamic. Vertical/Category-specific features enhance the model's ability to tailor behavioral features to different online shopping contexts, proving effective in improving product search ranking performance.

According to an example embodiment, a system is provided including a processor and a non-transitory computer-readable medium storing computing instructions that, when executed on the processor, cause the processor to perform operations including: obtaining a plurality of query-item pairs associated with a query, wherein the plurality of query-item pairs associated with the query are initially ranked at least partially based on user engagement metrics; obtaining, for each query-item pair of the plurality of query-item pairs associated with the query, first temporal-behavioral features, second temporal-behavioral features, and context-aware features, wherein the context-aware features include a vertical of the query; generating, using a Gradient Boosted Decision Tree (GBDT) model, respective query-item pair GBDT output values based on respective inputs for each query-item pair of the plurality of query-item pairs associated with the query, wherein the respective inputs for each query-item pair of the plurality of query-item pairs associated with the query are based on the first temporal-behavioral features, the second temporal-behavioral features, and the context-aware features; and re-ranking at least some of the plurality of query-item pairs associated with the query that are initially ranked based on the respective query-item pair GBDT output values.

According to an example embodiment, a computer-implemented method is provided including: extracting a vertical of a query; obtaining, for a plurality of query-item pairs associated with the query, first temporal-behavioral features for a first predetermined time window and second temporal-behavioral features for a second predetermined time window, wherein the first temporal-behavioral features for the first predetermined time window and the second temporal-behavioral features for the second predetermined time window each include respective user engagement metrics; inputting, to a gradient boosted decision tree (GBDT) model, the vertical of the query, the first temporal-behavioral features for the first predetermined time window, and the second temporal-behavioral features for the second predetermined time window; and re-ranking at least some query-item pairs of the plurality of query-item pairs associated with the query based on GBDT output values for the query-item pairs.

According to an example embodiment, a non-transitory computer-readable medium storing instructions that upon execution by a processor, cause the processor to perform operations including: obtaining a plurality of query-item pairs associated with a query, wherein the plurality of query-item pairs associated with the query are initially ranked by a baseline model at least partially based on user engagement metrics, token matching, and popularities of each query-item pair of the plurality of query-item pairs; obtaining, for each query-item pair of the plurality of query-item pairs associated with the query, first temporal-behavioral features, second temporal-behavioral features, and context-aware features from a query signal storage repository, wherein the context-aware features include a vertical of the query; generating, using a Gradient Boosted Decision Tree (GBDT) model, respective query-item pair GBDT output values based on respective inputs for each query-item pair of the plurality of query-item pairs associated with the query, wherein the respective inputs for each query-item pair of the plurality of query-item pairs associated with the query are based on the first temporal-behavioral features, the second temporal-behavioral features, and the context-aware features; and re-ranking at least some of the plurality of query-item pairs associated with the query that are initially ranked based on the respective query-item pair GBDT output values.

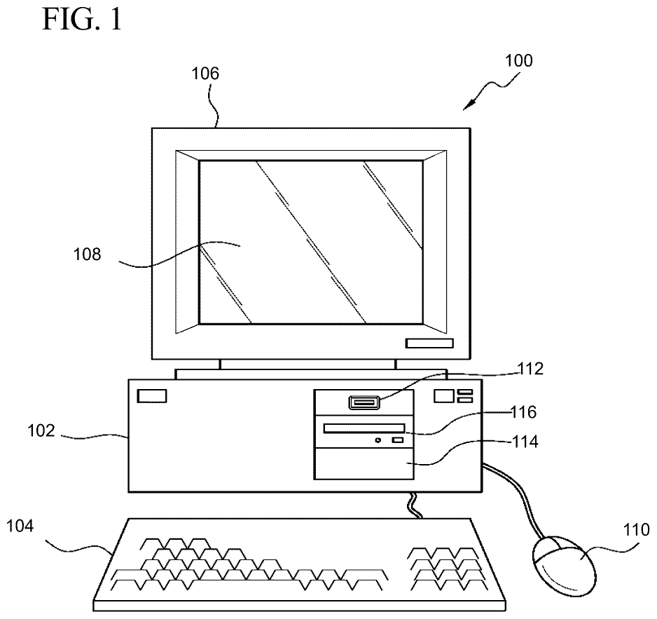

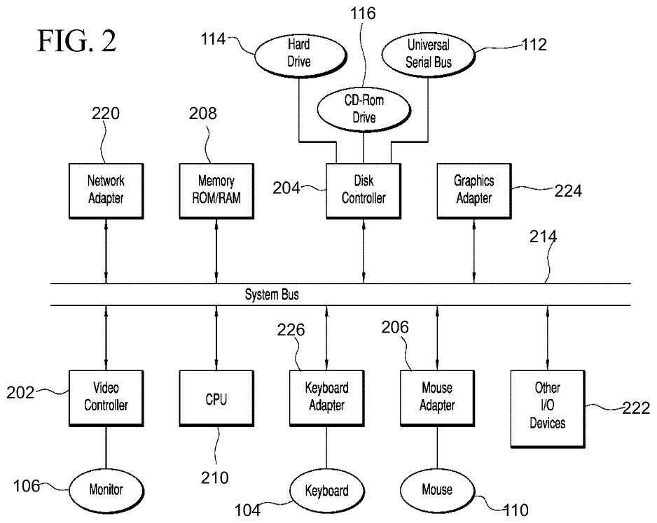

Turning to the drawings, FIG. 1 illustrates an example embodiment of a computer system 100, all of which or a portion of which can be suitable for (i) implementing at least partial or all example embodiments of the techniques, methods, and systems and/or (ii) implementing and/or operating part or all example embodiments of the non-transitory computer readable media described herein. As an example, a different or separate one of the computer system 100 (and its internal components, or at least one element of the computer system 100) can be suitable for implementing partial or all the techniques described herein. The computer system 100 can comprise a chassis 102 which can contain at least one circuit boards (not shown), a Universal Serial Bus (USB) port 112, a Compact Disc Read-Only Memory (CD-ROM), a Digital Video Disc (DVD) drive 116, and/or a hard drive 114. A representative block diagram of the elements included on the circuit boards inside the chassis 102 is shown in FIG. 2, according to an example embodiment. A central processing unit (CPU) 210 illustrated in FIG. 2 can be coupled to a system bus 214 in FIG. 2. In various example embodiments, an architecture of the CPU 210 can be compliant with a variety of commercially distributed architecture families.

Continuing with FIG. 2, a system bus 214 can be coupled to at least one memory storage unit 208 that can include both read only memory (ROM) and random access memory (RAM). Non-volatile portions of the memory storage unit 208 and/or the ROM can be encoded with a boot code sequence suitable for restoring the computer system 100 (FIG. 1) to a functional state, such as after a system reset. In addition, the memory storage unit 208 can include microcode, such as a Basic Input-Output System (BIOS). In some example embodiments, the at least one memory storage units of the various embodiments disclosed herein can include the memory storage unit 208, a USB-equipped electronic device (e.g., an external memory storage unit (not shown) coupled to the USB port 112 (FIGS. 1-2), the hard drive 114 (FIGS. 1-2), the CD-ROM, the DVD, the Blu-Ray, and/or other suitable media, such as media configured to be used for the CD-ROM and/or the DVD drive 116 (FIGS. 1-2). Non-volatile and/or non-transitory memory storage unit(s) can refer to the portions of the memory storage units(s) that are non-volatile memory and are not transitory signals. In the same or different example embodiments, the at least one memory storage units of the various embodiments disclosed herein can include an operating system, which can be a software program that manages the hardware and software resources of a computer and/or a computer network. The operating system can perform tasks such as, for example, at least one of controlling and/or allocating memory, prioritizing the processing of instructions, controlling input and/or output devices, facilitating networking, and/or managing files. Example operating systems can include at least one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further example operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” can mean various types of computational circuits, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, and/or various other types of processors and/or processing circuits capable of performing the desired functions. In some example embodiments, the at least one processors of the various embodiments disclosed herein can comprise the CPU 210.

In the example embodiment illustrated in FIG. 2, various I/O devices such as a disk controller 204, a graphics adapter 224, a video controller 202, a keyboard adapter 226, a mouse adapter 206, a network adapter 220, and/or other I/O devices 222 can be coupled to the system bus 214. The keyboard adapter 226 and/or the mouse adapter 206 can be coupled to a keyboard 104 (FIGS. 1-2) and/or a mouse 110 (FIGS. 1-2), respectively, of the computer system 100 (FIG. 1). The graphics adapter 224 and/or the video controller 202 can be indicated as distinct units in FIG. 2, the video controller 202 can be integrated into the graphics adapter 224, or vice versa in other example embodiments. The video controller 202 can be suitable for refreshing a monitor 106 (FIGS. 1-2) to display images on the screen 108 (FIG. 1) of the computer system 100 (FIG. 1). The disk controller 204 can control the hard drive 114 (FIGS. 1-2), the USB port 112 (FIGS. 1-2), the CD-ROM, and/or the DVD drive 116 (FIGS. 1-2). In other example embodiments, distinct units can be used to control each of these devices separately.

In some example embodiments, the network adapter 220 can comprise and/or be implemented as a WNIC (wireless network interface controller) card (not shown) plugged and/or coupled to an expansion port (not shown) in the computer system 100 (FIG. 1). In other example embodiments, the WNIC card can be a wireless network card built into computer system 100 (FIG. 1). A wireless network adapter can be built into the computer system 100 (FIG. 1), such as by having wireless communication capabilities integrated into the motherboard chipset (not shown) or implemented via at least one dedicated wireless communication chips (not shown), connected through a PCI (peripheral component interconnector), a PCI express bus of the computer system 100 (FIG. 1), and/or the USB port 112 (FIG. 1). In other example embodiments, the network adapter 220 can comprise and/or be implemented as a wired network interface controller card (not shown).

Although some components of the computer system 100 (FIG. 1) might not be shown in the figures, such components and their interconnection may be appreciated by those of ordinary skill in the art. Accordingly, further details concerning the construction and/or composition of the computer system 100 (FIG. 1) and/or the circuit boards inside the chassis 102 (FIG. 1) might be omitted herein.

When the computer system 100 in FIG. 1 is running, program instructions stored on a USB drive in the USB port 112, on the CD-ROM, the DVD in the CD-ROM, and/or the DVD drive 116, on the hard drive 114, and/or in the memory storage unit 208 (FIG. 2) can be executed by the CPU 210 (FIG. 2). At least a portion of the program instructions, such as stored on at least one of these devices, can be suitable for carrying out all or at least a part of the techniques described herein. In various example embodiments, the computer system 100 can be reprogrammed with at least one of at least one module, system, application, and/or database, such as those described herein, to convert a general purpose computer to a special purpose computer. For purposes of illustration, programs and other executable program components are shown herein as discrete systems, although it is understood that such programs and components may reside, at various times, in different storage components of computer system 100, and can be executed by the CPU 210. Additionally, or alternatively, the systems and/or procedures described herein can be implemented in hardware, and/or a combination of hardware, software, and/or firmware. For example, at least one application specific integrated circuit (ASIC) can be programmed to carry out at least one of the systems and procedures described herein. For example, at least one of the programs and/or executable program components described herein can be implemented in at least one ASIC.

Although the computer system 100 is illustrated as a desktop computer with reference to FIG. 1, it is not limited thereto. The computer system 100 can take a different form factor and can still having functional elements like those described with respect to the computer system 100. In some example embodiments, the computer system 100 can comprise at least one of at least one single computer, a single server, a cluster/collection of computers/servers, and/or a cloud of computers/servers. Typically, a cluster or collection of servers can be used when the demand on computer system 100 exceeds the reasonable capability of a single server and/or computer. In some example embodiments, the computer system 100 can comprise a portable computer, such as a laptop computer. In some example embodiments, the computer system 100 can comprise a mobile device, such as a smartphone. In some example embodiments, the computer system 100 can comprise an embedded system.

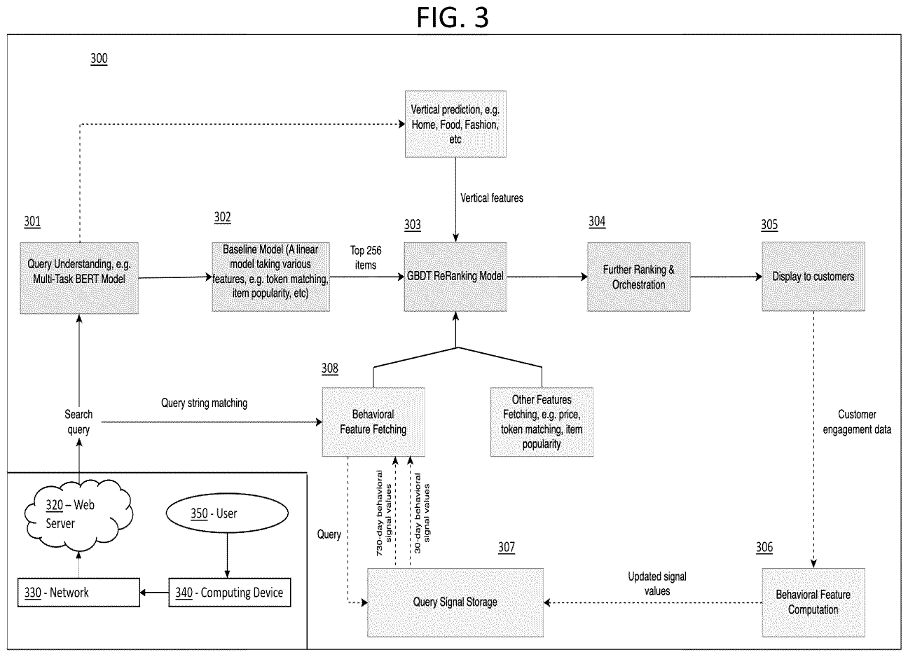

FIG. 3 illustrates a schematic block diagram of a system that can be used for ranking and/or re-ranking query search results (e.g., comprised of ranked and/or re-ranked items/products and/or ranked and/or re-ranked query-item (QIP)/query-product pairs) using temporal-behavioral features (e.g., hybridized behaviors and predetermined time window features) and context-aware features (e.g., verticals/categories, vertical/category features, and/or a predicted vertical/category), according to an example embodiment.

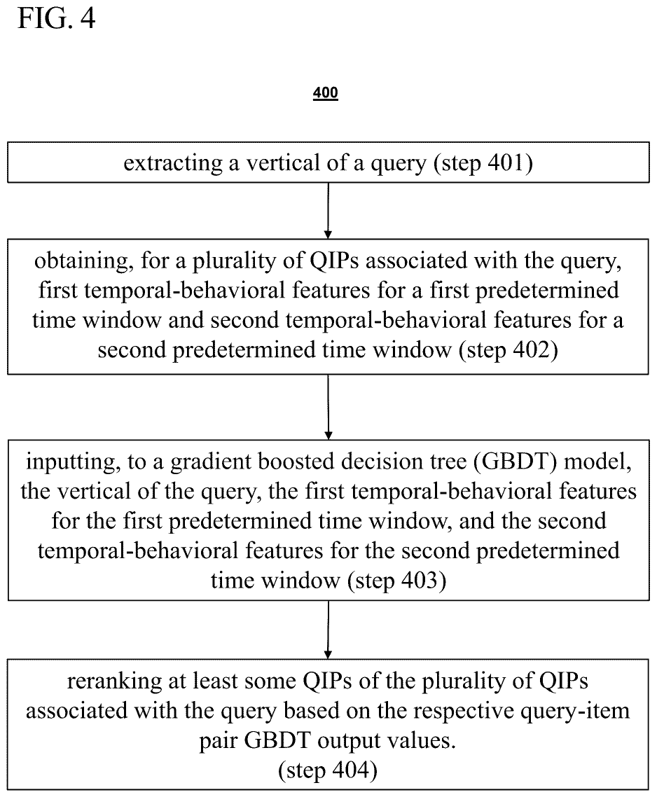

A system 300 can include system components, such as a decision tree model (e.g., a gradient boosted decision tree (GBDT) model/GBDT re-ranking model) 303 that can implement re-ranking query search results using temporal-behavioral and/or context-aware features (e.g., the example embodiment of the computer-implemented method 400 illustrated and described with reference to FIG. 4). The system 300 can further include one or more other system components, such as: a query-understanding model (e.g., multi-task bidirectional encoder representations from transformers (BERT) model) 301; a baseline model (e.g., a linear model) 302; a further ranking & orchestration module 304; a display to customers module 305; a behavioral feature computation module 306; a query signal storage repository 307; and a behavioral feature fetching module 308. The one or more other system components of the system 300 can be connectively coupled to the decision tree model 303 and/or one or more of the other system components of the system 300. The decision tree model 303; the further ranking & orchestration module 304; the display to customers module 305; the behavioral feature computation module 306; the query signal storage repository 307; and the behavioral feature fetching module 308 can collectively be referred to as a re-ranking query search results using temporal-behavioral and context-aware features sub-system of the system 300. The system 300 can be connected to a web server 320. The web server 320 can be connected to a network 330. The network 330 can be connected to and/or otherwise accessed by a computing device 340 of a user (e.g., customer) 350.

The system 300 can comprise a processor and a non-transitory computer-readable medium storing computing instructions that, when executed, cause the processor to perform various operations (e.g., via the system components and/or the other system components), which can include implementing the ranking of the items (QIPs), re-ranking of the items of the query search results (QIPs) using temporal-behavioral and/or context-aware features, and/or training the baseline model by inputting outputs of the decision tree model 303 and/or feedback therefor (e.g., subsequent user engagement metrics, user surveys, and/or GMV, etc.).

One or more of the system 300, the system components and/or the other system components thereof, and/or the web server 320 can include a computer system, such as the computer system 100 (illustrated and described with respect to FIG. 1), and one or more can be a single computer; a single server; a cluster or collection of computers or servers; a cloud of computers or servers; and/or a combination thereof. In some example embodiments, a single computer system can host the system 300, the system components and/or other system components thereof, and/or the web server 320.

In some example embodiments, the web server 320 can be in data communication with at least one computing device 340 of at least one user 350 via the network 330. Types of the user 350 can include an expert (e.g., individual that manages, trains, tunes/updates, maintains, monitors and/or audits performance metrics of the system 300, the system components, and/or other system components thereof), etc. Associated interfaces and permissions related to the system 300 can differ as appropriate for the type of the computing device 340, the user 350, predetermined authorizations, and/or predetermined purposes of the user 350. The computing device 340 can be included in the system 300 or external to system 300 and communicatively coupled thereto via the network 330. The network 330 can be the Internet or another suitable network for inter-device connectivity. In some example embodiments, the web server 320 can host the system 300, websites connected thereto (e.g., an e-commerce website), and/or mobile application servers, etc. For example, the web server 320 can host the system 300, a website connected thereto, and/or one or more of the system components and/or the other system components of the system 300, and/or can provide a server that interfaces with an application (e.g., a mobile application), on the computing device 340. This can allow for the user 350 to passively and/or actively engage with the system 300 to assist the user 350 by re-ranking query search results using temporal-behavioral features and/or context-aware features and/or enabling performance of activities associated with the expert, respectively.

In some example embodiments, an internal network that is not open to the public can be used for communications between the system 300, the system components and/or the other system components thereof, a database system, the website, and/or the web server 320 connected to the system 300. Accordingly, in some example embodiments, the system 300, the system components and/or the other system components, and/or software used thereby can refer to a back end of a system operated by the expert and/or a network administrator of the system 300. The web server 320 (and/or software used by such systems) can refer to a front end of system and/or the system 300, which can be accessed and/or otherwise used by the user 350 via the computing device 340. In these or other example embodiments, the expert and/or the network administrator of the system 300 can manage the system 300, the system components and/or the other system components of the architecture thereof, the processor(s) of the system 300, and/or the memory storage unit(s) of the system 300 using the input device(s) and/or display device(s) of the system 300.

In some example embodiments, the computing device 340 can include a desktop computer, a laptop computer, a mobile device, and/or another endpoint device used by the user 350. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.).

In some example embodiments, the system 300, the system components and/or the other system components, and/or the web server 320 can each include at least one input device (e.g., at least one keyboards, at least one keypads, at least one pointing devices such as a computer mouse or computer mice, at least one touchscreen displays, a microphone, etc.), and/or can include at least one display device (e.g., at least one monitor, at least one touch screen display, projector, etc.). In these example embodiments or other example embodiments, at least one of the input device(s) can be similar or identical to the keyboard 104 (FIG. 1) and/or the mouse 110 (FIG. 1). Further, at least one of the display device(s) can be similar or identical to the monitor 106 (FIG. 1) and/or the screen 108 (FIG. 1). The input device(s) and the display device(s) can be coupled to the system 300, the system components and/or the other system components of the architecture thereof, and/or the web server 320 in a wired manner and/or a wireless manner, and the coupling can be direct and/or indirect, as well as local and/or remote. As an example of an indirect manner (which may or may not also be a remote manner), a keyboard-video-mouse (KVM) switch can be used to couple the input device(s) and the display device(s) to the processor(s) and/or the memory storage unit(s). In some example embodiments, the KVM switch also can be part of the system 300, the system components and/or the other system components, and/or the web server 320. In a similar manner, the processors and/or the non-transitory computer-readable media can be local and/or remote to each other.

In some example embodiments, the system 300, the system components and/or the other system components, and/or the web server 320 can be further connected to communicate with at least one database system. The at least one database system can include and/or be connected to one or more repositories that can include, for example: training datasets for the system 300, the system components (e.g., a decision tree model) and/or the other system components (e.g., the baseline model 302); performance metrics/feedback data for the system 300, the system components and/or the other system components; aggregated historical user engagement data and/or individual/aggregate user engagement data/metrics; QIPs/query-product pairs; product/item catalog data and/or features; queries and/or features; verticals/categories, vertical/category features, and/or predicted verticals/categories for queries and/or QIPs; other features (e.g., associated with initial ranking (e.g., by the baseline model 302)); identifying data for the user 350 and/or the computing device 340; user behaviors/trends, item/product, and/or vertical/category preferences/interests; and/or rankings and/or re-rankings of products/items and/or QIPs/query-product pairs associated with a plurality of queries, etc.

The database system and/or repositories/databases connected thereto (e.g., the query signal storage repository 307) can be stored in at least one memory storage units (e.g., non-transitory computer readable media), which can be similar or identical to the at least one memory storage units (e.g., non-transitory computer readable media) described above with respect to computer system 100 (FIG. 1). Also, in some embodiments, one or more databases/repositories included and/or connected to the database system can be stored on a single memory storage unit, or the contents of that particular database can be spread across multiple ones of the memory storage units storing the at least one databases, depending on the size of the particular database and/or the storage capacity of the memory storage units.

The at least one databases can each include a structured (e.g., indexed) collection of data and can be managed by a suitable database management systems configured to define, create, query, organize, update, and manage database(s). Example database management systems can include MySQL (Structured Query Language) Database, PostgreSQL Database, Microsoft SQL Server Database, Oracle Database, SAP (Systems, Applications, & Products) Database, and IBM DB2 Database.

The system 300, the system components and/or the other system components, the web server 320, the database system and/or the at least one repositories/databases can be implemented using a suitable manner of wired and/or wireless communication. Accordingly, the system 300 can include software and/or hardware components configured to implement the wired and/or wireless communication. Further, the wired and/or wireless communication can be implemented using a singular or plural combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Example PAN protocol(s) can include Bluetooth, Zigbee, Wireless Universal Serial Bus (USB), Z-Wave, etc.; example LAN and/or WAN protocol(s) can include Institute of Electrical and Electronic Engineers (IEEE) 802.3 (also known as Ethernet), IEEE 802.11 (also known as WiFi), etc.; and example wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, example communication hardware can include wired communication hardware including, for example, at least one data buses, such as, for example, universal serial bus(es), at least one networking cables, such as, for example, coaxial cable(s), optical fiber cable(s), and/or twisted pair cable(s), any other suitable data cable, etc. Further example communication hardware can include wireless communication hardware including, for example, at least one radio transceivers, at least one infrared transceivers, etc. Additional example communication hardware can include at least one networking components (e.g., modulator-demodulator components, gateway components, etc.).

In many embodiments, the system 300 can be suitable to perform the computer-implemented method for re-ranking query search results using temporal-behavioral and context-aware features, such as the example embodiment thereof illustrated and described with reference to FIG. 4. In these or other example embodiments, one or more of the activities/steps of the example embodiment of the computer-implemented method 400 can be implemented as one or more computing instructions configured to run at one or more processors and configured to be stored at one or more non-transitory computer readable media. Such non-transitory computer readable media can be part of system 300, the system components, and/or the other system components thereof. The processor(s) can be similar or identical to the processor(s) described above with respect to the computer system 100 (FIG. 1). In some embodiments, the example embodiment of the computer-implemented method 400 of FIG. 4 and other steps/activities that can be included therein can include using a distributed network including distributed memory architecture to perform the associated steps/activities. This distributed architecture can reduce the impact on the network 330 and the system 300 resources to reduce congestion in bottlenecks while still allowing data to be accessible from a central location.

FIG. 4 illustrates a flowchart of the computer-implemented method for re-ranking query search results using temporal-behavioral and context-aware features, according to an example embodiment. An example embodiment can include a computer-implemented method 400 for re-ranking query search results using temporal-behavioral and context-aware features:
extracting a vertical of a query (step 401);
obtaining, for a plurality of QIPs associated with the query, first temporal-behavioral features for a first predetermined time window and second temporal-behavioral features for a second predetermined time window (step 402), wherein the first temporal-behavioral features for the first predetermined time window and the second temporal-behavioral features for the second predetermined time window each include respective user engagement metrics;
inputting, to a gradient boosted decision tree (GBDT) model, the vertical of the query, the first temporal-behavioral features for the first predetermined time window, and the second temporal-behavioral features for the second predetermined time window (step 403); and
reranking at least some QIPs of the plurality of QIPs associated with the query based on the QIP GBDT output values (step 404).

The query-understanding model 301 can generate a query string and/or process the one or more queries to extract features, such as vertical (also referred to herein as category) features and/or a vertical/vertical prediction based thereon, semantic features, and/or syntactic features, etc. The semantic features can capture the meaning of the query. The syntactic features can analyze the structure of the query. The query-understanding model 301 can normalize related queries of the one or queries that are within a predetermined threshold of similarity based on the extracted features. The vertical features and/or the vertical/vertical prediction can be used to categorize the query (and consequently associated items (e.g., products) and/or QIPs into one or more specific verticals, such as Food, Consumable, Home, Hardlines, Fashion, and/or Electronics, Technology, and Software (ETS), etc. The verticals can also include sub-verticals. For example, a sub-vertical for food can include organic produce, a sub-vertical for fashion can include coats, and/or a sub-vertical for electronics can include video game consoles. These extracted features can help the system 300, the system components, and/or the other system components in understanding the context and intent behind the one or more queries of one or more users, allowing the system 300, the system components, and/or the other system components to effectuate tailored search results more effectively.

The baseline model 302 can initially rank the query-item pairs (QIPs) based on user engagement metrics (e.g., clicks, add-to-carts, orders, etc.), token matching measures, item popularities, other relevant features, and/or calculated/predetermined weights and/or biases thereof. In e-commerce, QIPs can refer to the relationship between a user's search query and the items returned as results. This can also be called query-product pairs in a more specific context. The other relevant features can include, for example: user preferences/behaviors/trends, token matching (can measure how well the tokens in the query match with tokens in potential items, using techniques like TF-IDF and/or word embeddings); item, QIP, and/or query popularities (can be derived from historical user interaction/engagement data, considering how frequently items of QIPs are viewed, clicked, and/or purchased, etc.), etc. The baseline model 302 can select/output a predetermined number (e.g., 256) of top QIPs associated with the query, which can be ranked based on one or more of the token matching measures, the item popularities, the other relevant features, and/or the calculated/predetermined weights and/or biases thereof. The initial ranking of the items and/or QIPs and underlying features can provide a foundation for further refinement/re-ranking, for example, by the decision tree model 303.

The decision tree model 303 can represent a machine learning model that combines multiple decision trees to improve prediction accuracy. The decision tree model 303 can obtain one or more combined feature vectors (e.g., from the query signal storage repository 307 as discussed below). The one or more combined feature vectors can include first temporal-behavioral features, second temporal-behavioral features, context-aware features, and/or the other features such as price, token matching measures, and/or the item (QIP) popularities. The first temporal-behavioral features can represent user engagement metrics over a longer, first predetermined time window (e.g., one year, two years, etc.) and the second temporal-behavioral features can represent user engagement metrics over a shorter, second predetermined time window (e.g., one month, two months, etc.). The context-aware features which can include the vertical features, can be one-hot encoding to indicate the product vertical, and/or other contextual information like location and/or time of day.

Training the decision tree model 303 can involve adding decision trees (e.g., sequentially), in which each decision tree can correct errors from the previous decision tree and can use a loss function to minimize residuals. Hyperparameters such as learning rate and the number of decision trees can be tuned to balance model accuracy and/or overfitting. The decision tree model 303 can comprise multiple decision trees, each of which can be built in a sequential manner to correct the errors of the previous trees. Each decision tree in the decision tree model 303 can be composed of nodes, which can include internal nodes and leaf nodes. The internal nodes can represent decision points based on input features and values therefor, while leaf nodes can represent the final output and/or prediction. In the context of the system 300, the decision tree model 303 can use the combined feature vectors for the items and/or the QIPs associated with the query as inputs. These combined feature vectors for the items and/or the QIPs associated with the query can include first temporal-behavioral features, second temporal-behavioral features, context-aware features, and/or various other features such as price, token matching measures, and item popularity. The first temporal-behavioral features can represent user engagement metrics over a longer time window, such as two years. They can capture long-term user behavior patterns. The second temporal-behavioral features can represent user engagement metrics over a shorter time window, such as thirty days. They can capture short-term user behavior patterns. The context-aware features can include the vertical features (one-hot encoded to indicate the product category), location, time of day, and/or other contextual information, etc. The other features can include price, the token matching measures, and/or the item popularities.

The decision tree model 303 can learn to modify (e.g., rearrange, add, and/or subtract decision trees, nodes, leaf nodes, arrangements/hierarchies of nodes, and/or leaf nodes, etc.) to reflect the Bayesian inference framework outputs and/or relative determined influence of each of the first behaviors, second behaviors, first predetermined time window, and/or second predetermined time window on user engagement metrics for a vertical. For example, the decision tree model 303 can learn to restructure itself (e.g., decision trees, nodes, leaf nodes, positions, and/or arrangements/hierarchies thereof) in such a manner as to increase or decrease the relative effect of a predetermined first or second predetermined time window, and/or omit a first or second predetermined time window node and/or corresponding leaf nodes entirely if the influence according to the outputs of the Bayesian inference framework is below a predetermined threshold.

The decision tree model 303 can use these features to make predictions. Each internal node in a decision tree can evaluate a specific feature and can decide based on its corresponding value, directing the flow to the next node. This process can continue until a leaf node is reached, which can provide the relevance score for the QIP. The outputs from the decision tree model 303 can include GBDT output values (e.g., relevance scores) for at least some/each QIPs, which can indicate the relevance of the at least some/each item(s) to the user's query. These GBDT output values for the QIPs can subsequently be used to re-rank the initially ranked QIPs form the baseline model 302, providing a more accurate and contextually relevant ordering of search results. The relevance scores from all the decision trees in the decision tree model 303 can be aggregated to produce the final GBDT output value for each QIP.

The further ranking & orchestration module 304 can receive the relevance scores output by the decision tree model 303 as inputs. The further ranking & orchestration module 304 can dynamically perform the re-ranking of the items and/or the QIPs associated with the query and/or can perform the re-ranking of the items and/or QIPs based on the system 300 identifying one or more predetermined triggering conditions. The one or more triggering conditions can include: a new query input by a user (e.g., the new query string is determined to match a stored query string); a predetermined time interval elapsing, range, date, season and/or time; predetermined events (e.g., a sale, a viral item, negative press about an item, change in individual user preferences, new product launch, etc.), and/or a predetermined threshold quantity and/or magnitude of change in newly collected user engagement metrics associated with the query and/or associated items/QIPs thereof. This can ensure that the initial ranking is updated (re-ranked) based on ongoing aggregated historical user engagement data and user interactions, allowing the system 300 to adapt output search results for a query to changing user behaviors and/or preferences. The re-ranked items and/or QIPs associated with the query and relative updates can be input to the baseline model 302 as feedback for the baseline model 302 to learn/improve its output of initial rankings.

The display to customers module 305 can transmit the re-ranked search results (re-ranked items and/or QIPs associated with the query) to one or more users (e.g., a user that input the query and/or a new query obtained by the system 300). The display to customers module 305 can generate computer-readable program instructions to present the re-ranked search results to a graphical user interface (GUI) of a computing device 340 of one or more users 350 via the network 330, ensuring that the most relevant items are displayed based on the re-ranked items and/or QIPs associated with a given query. The display to customers module 305 can be the final presentation layer, where the user 350 sees the search results in a re-ranked order that reflects their relevance and contextual appropriateness. The display to customers module 305 can further modify the computer-readable medium of the system 300 and/or generate computer-readable instructions therefor to perform the re-ranking of the initial ranked items and/or QIPs associated with the query. Additionally, this module can output the aggregated user engagement data (e.g., historical) to the behavioral feature computation module 306.

The behavioral feature computation module 306 can compute the temporal-behavioral features, such as by using the Bayesian inference framework. The Bayesian inference framework can process the aggregated historical user engagement data, which can include first user behaviors from a first predetermined time window and second user behaviors from a second predetermined time window. The Bayesian inference framework can output the first temporal-behavioral features based on the first user behaviors and the first predetermined time window, and the second temporal-behavioral features based on the second user behaviors and the second predetermined time window. This approach can allow the decision tree model 303 to capture both long-term and short-term user engagement patterns, providing a more comprehensive understanding of user behaviors. The Bayesian inference framework utilizes several key components: engagement counts (b), the number of times users engage with items (e.g., clicks, add-to-cart actions); examine counts (e), the number of times users examine items without engaging (e.g., views without clicks); priors (α, β), initial beliefs about user behavior before observing the data; query-product pair (q, p), the specific combination of a user query and a product; and look-back time window (T), the period over which historical engagement and examine data are aggregated:

$${behavorial\_feature}_{q , p} ∼ Beta ( {\sum }_{t ∈ T} {b}_{q , p}^{( t )} + α , {\sum }_{t ∈ T} {e}_{q , p}^{( t )} - {\sum }_{t ∈ T} {b}_{q , p}^{( t )} + β )$$

The processing by the Bayesian inference framework can be performed offline, and the query signal storage repository 307 that stores outputs thereof can also be offline until a predetermined triggering condition is identified by the system 300.

The relationship between the Bayesian inference framework and the decision tree model 303 can be as follows: the Bayesian inference framework can process historical user engagement data to generate the first and second temporal-behavioral features. The first and second temporal-behavioral features, along with context-aware features and/or other relevant features, can be combined to form combined feature vectors for each QIP associated with the query. The decision tree model 303 can be trained using these combined feature vectors for the items and/or QIPs associated with the query. Each decision tree in the decision tree model 303 can use the features output by the Bayesian inference framework to make decisions at its nodes, ultimately producing relevance scores at the leaf nodes. The GBDT output values (e.g., the relevance scores) generated by the decision tree model 303 can be used to re-rank the QIPs associated with the query (e.g., using the further ranking & orchestration module 304), ensuring that the most relevant items are presented to the user.

The query signal storage repository 307 can store query signals and the user engagement data (e.g., the aggregated historical user engagement data), including the first and second temporal-behavioral features output by the Bayesian inference framework. The query signal storage repository can act as a database/repository in which some or all the data for decision tree model 303 feature computation, analysis, and/or retrieval is stored. The query signal storage repository 307 can ensure that the system 300 has access to a rich dataset of historical user interactions for one or more predetermined time windows, which can be used to compute the various features needed for re-ranking according to various example embodiments disclosed herein. The behavioral feature computation module 306 can output updated behavioral signals to the query signal storage repository 307. The behavioral feature computation module 306 can generate outputs by the Bayesian inference framework (e.g., included therewith) based upon the system 300 identifying the same or different predetermined conditions of the one or more predetermined conditions associated with the decision tree model 303, continuously, and/or within a predetermined period of time of obtaining a predetermined size of new aggregate historical user engagement data.

The behavioral feature fetching module 308 can retrieve the first and second temporal-behavioral features for the QIPs from the query signal storage repository 307. The behavioral feature fetching module 308 can match an input query string generated/output by the query-understanding model 301 to a previously stored query string in the query signal storage repository 307 based on a predetermined threshold of similarity. When the query string matches a stored query string, the behavioral feature fetching module 308 can retrieve the first and second temporal-behavioral features and/or other relevant features such as price, token matching measures, and/or item popularity associated with the query, etc. The behavioral feature fetching module 308 can ensure that the system 300 can efficiently access and utilize the stored data to compute the combined feature vectors needed for the decision tree model 303 to re-rank the items and/or the QIPs associated with the query and output the GBDT output values. The system 300 can generate combined feature vectors for the respective items and/or QIPs by concatenating the respective first and second temporal-behavioral features with the context-aware features for each QIP and/or aggregate QIPs for a query. These combined feature vectors can then be input into the decision tree model 303 which can output the relevance scores used in re-ranking the items and/or the QIPs associated with the query. The combined feature vectors for the items and/or QIPs associated with the query can provide a comprehensive representation of each constituent QIP, which can incorporate temporal, behavioral, and/or contextual information, etc.

The system 300 can identify the one or more triggering conditions to re-rank the QIPs based on real-time and or aggregated historical user engagement data. Aggregated historical user engagement data can be used to refine GBDT output values (e.g., relevance scores) dynamically. For example, items of QIPs that are recently popular but were not in the past can be lifted post re-ranking using short-term customer engagement (CE) features, which previous models were not able to achieve. This dynamic re-ranking can ensure that the system 300 can adapt to changing trends and/or user preferences, providing more relevant re-ranked search results for items and/or the QIPs associated with the query. Vertical signals can tailor temporal-behavioral features to different online shopping contexts. For instance, fashion items/QIPs may have more important predictors based on 1-month customer engagement signals, while consumables may rely more on 2-year engagement signals. This approach can ensure that the system 300 can effectively handle the combined feature vectors and accurately predict relevance scores for each item and/or QIPs associated with the query, thus improving the overall relevance and user satisfaction of the re-ranked search results.

By leveraging these components and processes, the system 300 can provide a comprehensive and dynamic method for re-ranking query search results, ensuring that the final ranking is highly relevant and tailored to the user's query and context. This method can include extracting the vertical of the query, obtaining temporal-behavioral features over different time windows, and dynamically updating rankings based on real-time and/or historical data and user interactions therein. The system 300 can thus incorporate both long-term and short-term user engagement metrics (and/or adjust relative priorities thereof in overall relevance scores) along with context-aware features, which can significantly enhance the relevance and accuracy of search results for the items and/or the QIPs associated with a given query and/or vertical thereof.

The methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMS, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these example embodiments will be apparent to those skilled in the art and may be made without departing from the scope or spirit of these disclosures.

Although example embodiments of a computer-implemented method for re-ranking query search results using temporal-behavioral and context-aware features, example embodiments of the system 300 and/or computer-readable program instructions therefor have been illustrated and described herein, it shall be understood by those skilled in the art that various changes may be made without departing from the spirit or scope of the disclosure. Accordingly, the disclosure of the example embodiments is intended to be illustrative of the scope of the disclosure and is not intended to be limiting. It is intended that the scope of the disclosure shall be limited only to the extent required by the appended claims.

Replacement of at least one claimed element constitutes reconstruction and not repair. Additionally, benefits, other advantages, and solutions to problems have been described regarding example embodiments. The benefits, advantages, solutions to problems, and any element or elements that may cause any benefit, advantage, or solution to occur or become more pronounced, however, are not to be construed as critical, required, or essential features or elements of any or all the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing computing instructions that, when executed on the processor, cause the processor to perform operations comprising:
obtaining a plurality of query-item pairs associated with a query, wherein the plurality of query-item pairs associated with the query are initially ranked at least partially based on user engagement metrics;
obtaining, for each query-item pair of the plurality of query-item pairs associated with the query, first temporal-behavioral features, second temporal-behavioral features, and context-aware features, wherein the context-aware features include a vertical of the query;
generating, using a Gradient Boosted Decision Tree (GBDT) model, respective query-item pair GBDT output values based on respective inputs for each query-item pair of the plurality of query-item pairs associated with the query, wherein the respective inputs for each query-item pair of the plurality of query-item pairs associated with the query are based on the first temporal-behavioral features, the second temporal-behavioral features, and the context-aware features; and
re-ranking at least some of the plurality of query-item pairs associated with the query that are initially ranked based on the respective query-item pair GBDT output values.

2. The system of claim 1, wherein the operations further comprise:
obtaining aggregated historical user engagement data for the query-item pairs associated with the query,
wherein:
the aggregated historical user engagement data for the query-item pairs associated with the query includes, for each query-item pair of the plurality of query-item pairs associated with the query, first user behaviors from a first predetermined time window and second user behaviors from a second predetermined time window; and
the first user behaviors from the first predetermined time window and the second user behaviors from the second predetermined time window include the user engagement metrics.

3. The system of claim 2, wherein obtaining the first temporal-behavioral features and the second temporal-behavioral features further comprises:
inputting, to a Bayesian inference framework, the first user behaviors, the first predetermined time window, the second user behaviors, and the second predetermined time window; and
outputting, by the Bayesian inference framework, the first temporal-behavioral features based on the first user behaviors and the first predetermined time window, and the second temporal-behavioral features based on the second user behaviors and the second predetermined time window.

4. The system of claim 2, wherein obtaining the first temporal-behavioral features and the second temporal-behavioral features further comprises:
generating a query string for the query;
matching the query string for the query to a stored query string for the query; and
retrieving the first temporal-behavioral features and the second temporal-behavioral features from a query signal storage repository.

5. The system of claim 2, wherein the first predetermined time window is a longer period of time than the second predetermined time window.

6. The system of claim 1, wherein the operations further comprise:
generating the respective inputs by concatenating the first temporal-behavioral features and the second temporal-behavioral features with the context-aware features to generate a combined feature vector for each query-item pair of the plurality of query-items pairs associated with the query; and
training the GBDT model based on the combined feature vector for each query-item pair of the plurality of query-item pairs associated with the query.

7. The system of claim 1, wherein the user engagement metrics include user click metrics, user add-to-cart metrics, and user order metrics.

8. The system of claim 1, wherein the operations further comprise:
identifying a triggering condition to perform the re-ranking of at least some of the plurality of query-item pairs associated with the query that are initially ranked based on the query-item pair GBDT output values, wherein the triggering condition includes one or more of a query input by a user, a predetermined time interval elapsing, or a predetermined threshold of new user engagement metrics associated with the query.

9. The system of claim 1, wherein the operations further comprise:
using a multi-task Bidirectional Encoder Representations from Transformers (BERT) model to extract the vertical of the query, wherein the vertical of the query includes one or more of home, food, fashion, or electronics.

10. The system of claim 6, wherein the GBDT model, as trained, includes one or more vertical nodes and one or more of first temporal-behavioral leaf nodes and second temporal-behavioral leaf nodes of each of the one or more vertical nodes.

11. A computer-implemented method comprising:
extracting a vertical of a query;
obtaining, for a plurality of query-item pairs associated with the query, first temporal-behavioral features for a first predetermined time window and second temporal-behavioral features for a second predetermined time window, wherein the first temporal-behavioral features for the first predetermined time window and the second temporal-behavioral features for the second predetermined time window each include respective user engagement metrics;
inputting, to a gradient boosted decision tree (GBDT) model, the vertical of the query, the first temporal-behavioral features for the first predetermined time window, and the second temporal-behavioral features for the second predetermined time window; and
re-ranking at least some query-item pairs of the plurality of query-item pairs associated with the query based on GBDT output values for the query-item pairs.

12. The computer-implemented method of claim 11, wherein the obtaining, for a plurality of query-item pairs associated with the query, first temporal-behavioral features for a first predetermined time window and second temporal-behavioral features for a second predetermined time window further comprises:
generating a query string for the query;
matching the query string for the query to a stored query string for the query; and
retrieving the first temporal-behavioral features and the second temporal-behavioral features from a query signal storage repository.

13. The computer-implemented method of claim 12, further comprising:
obtaining aggregated historical user engagement data for the plurality of query-item pairs associated with the query,
wherein:
the aggregated historical user engagement data for the plurality of query-item pairs associated with the query includes, for each query-item pair of the plurality of query-item pairs associated with the query, first user behaviors for a first predetermined time window and second user behaviors for a second predetermined time window; and
the first user behaviors from the first predetermined time window and the second user behaviors from the second predetermined time window include the respective user engagement metrics.

14. The computer-implemented method of claim 13, further comprising:
retrieving other features for the query-item pairs associated with the query from the query signal storage repository based on the matching the query string for the query to a stored query string for the query, wherein the other features include price, token matching, and popularity.

15. The computer-implemented method of claim 13, further comprising:
inputting, to a Bayesian inference framework, the first user behaviors for the first predetermined time window and the second user behaviors for the second predetermined time window; and
outputting, by the Bayesian inference framework, the first temporal-behavioral features and the second temporal-behavioral features.

16. The computer-implemented method of claim 15, wherein the outputting, by the Bayesian inference framework, first temporal-behavioral features and second temporal-behavioral features is performed offline, wherein the first temporal-behavioral features and second temporal-behavioral features are stored offline in the query signal storage repository, and wherein the retrieving the first temporal-behavioral features and the second temporal-behavioral features from a query signal storage repository occurs upon a triggering condition.

17. The computer-implemented method of claim 11, wherein the respective user engagement metrics include user click metrics, user add-to-cart metrics, and user order metrics.

18. The computer-implemented method of claim 11, wherein the first predetermined time window is a longer period of time than the second predetermined time window.

19. The computer-implemented method of claim 11, wherein the plurality of query-item pairs associated with the query are initially ranked by a baseline model, wherein the baseline model is a linear model.

20. A non-transitory computer-readable medium storing instructions that upon execution by a processor, cause the processor to perform operations comprising:
obtaining a plurality of query-item pairs associated with a query, wherein the plurality of query-item pairs associated with the query are initially ranked by a baseline model at least partially based on user engagement metrics, token matching, and popularities of each query-item pair of the plurality of query-item pairs;
obtaining, for each query-item pair of the plurality of query-item pairs associated with the query, first temporal-behavioral features, second temporal-behavioral features, and context-aware features from a query signal storage repository, wherein the context-aware features include a vertical of the query;
generating, using a Gradient Boosted Decision Tree (GBDT) model, respective query-item pair GBDT output values based on respective inputs for each query-item pair of the plurality of query-item pairs associated with the query, wherein the respective inputs for each query-item pair of the plurality of query-item pairs associated with the query are based on the first temporal-behavioral features, the second temporal-behavioral features, and the context-aware features; and
re-ranking at least some of the plurality of query-item pairs associated with the query that are initially ranked based on the respective query-item pair GBDT output values.
